(19) United States
(12) Patent Application Publication
(10) Pub. No.: US 2004/0250622 A1
(43) Pub. Date: Dec. 16, 2004

(54) Resonator sensor assembly

(75) Inventors: Oleg Kolosov, San Jose, CA (US); Leonid Matsiev, San Jose, CA (US); John F. Varni, Los Gatos, CA (US); G. Cameron Dales, Saratoga, CA (US)

Correspondence Address: DOBRUSIN & THENNISCH PC, 29 W LAWRENCE ST, SUITE 210, PONTIAC, MI, 48342, US

(73) Assignee: Symyx Technologies, Inc.

(21) Appl. No.: 10/804,379

(22) Filed: Mar. 19, 2004

Related U.S. Application Data
(60) Provisional application No. 60/456,517, filed on Mar. 21, 2003.

(51) Int. Cl. G01N 24/00

(52) U.S. Cl. 73/570

(57) ABSTRACT

An improved method and assembly, wherein the method generally includes the steps of providing a coated or uncoated sensor element having an exposed sensing surface; attaching the sensor element to a platform so that the exposed sensing surface is spaced from the platform; and optionally applying a protective layer over the platform while maintaining the sensing surface as exposed. The assembly includes a resonator having a free portion with a sensing surface is incorporated onto a platform, components of the sensor are physically shielded from harsh operating conditions, the requisite space is maintained between the free portion of the resonator and the platform, and the sensing surface of the resonator remains exposed for sensing.

### CLAIM OF PRIORITY

This application claims the benefit of U.S. Provisional Application No. 60/456,517, filed on Mar. 21, 2003.

### TECHNICAL FIELD

The present invention relates generally to the assembly of sensing devices, and more particularly to the packaging of fluid condition sensors such as for the sensing of synthetic or natural petroleum fluids.

### BACKGROUND

U.S. Provisional Application Ser. No. 60/419,404, (entitled “Machine Fluid Sensor and Method”; filed Oct. 18, 2002)(hereby incorporated by reference) discloses improved machine fluid sensors and methods. There is a need for the ability to package sensing devices so that they can withstand their operating conditions. Exemplary applications in which these sensors may be used in engines in general, automobiles, heavy machinery, military equipment, airplane parts, oil drilling, exploration and production well logging, oil refining, pipeline and quality control applications, marine transportation, sub-sea exploration and aerospace related equipment, or any other fluid containing application. In general, sensors for these applications will include very small components that need to be able to withstand harsh operating environment conditions. The ability to assemble such devices efficiently using automated materials handling equipment is also important.

### SUMMARY OF THE INVENTION

In general, the present invention meets the above needs by providing an improved method that generally includes the steps of:

providing a coated or uncoated sensor element having an exposed sensing surface;

attaching the sensor element to a platform so that the exposed sensing surface is spaced from the platform; and

optionally applying a protective layer over the platform and/or sensor while maintaining the exposed sensing surface.

A highly preferred sensor of the present invention includes a resonator, and more preferably a tuning fork resonator.

Among other advantages, the present invention affords the ability to provide improved sensor assemblies for a number of different applications. The sensor assemblies of the present invention thus preferably include at least one and more preferably a combination of two or more of the following:

operates for long periods of time (e.g., at least 3 months, and more preferably at least 1 year or longer) over a temperature range of −40° C. to 170° C. and more preferably −60° C. to 300° C., without compromise to the material sensor performance characteristics;

provides protection to fragile components that are typically small (e.g., smaller than 5 mm, and in some instances having a smallest dimension that is smaller than 1 mm), in harsh environments such as environments that include corrosive media, abrasive media, or combinations thereof;

provides a packaged device that is compact (e.g., smaller than about 15 cm³, having a footprint of less than about 40 cm², and more preferably smaller than about 10 cm³, having a footprint of less than about 20 cm²), which can be used alone or combined with other components, such as an application specific integrated circuit (ASIC) onto a common platform (e.g., a lead frame or the like);

includes individual or modular components that can be readily handled by automated materials handling equipment, such as components including a flat surface for handling by “pick and place” robots; or

includes structure that permits for calibration of the sensor against a material having a known characteristic or for initializing the sensor upon introduction of a new fluid.

Accordingly, it can be seen that the present invention provides a solution for a number of competing technological challenges; notably, for example, the preparation of an assembly in which a sensor having a free portion with a sensing surface is incorporated onto a platform, components of the sensor are physically shielded from harsh operating conditions, the requisite space is maintained between the free portion of the sensor and the platform, and the sensing surface of the sensor remains exposed for sensing.

### BRIEF DESCRIPTION OF THE DRAWINGS

FIG. 1 is a side section view of a sensor of the present invention taken from the assembly of FIG. 2;

FIG. 2 is a perspective view of the sensor of FIG. 2 depicting an illustrative housing configuration;

FIG. 3 is a side section view of a sensor of the present invention, shown coupled with another component and sharing a common platform, and also including an optional protective layer;

FIG. 4 is a top sectional view of an assembly in accordance with the present invention to illustrate the use of a removable barrier for temporary use while applying a protective layer to components of a sensor in accordance with the present invention;

FIGS. 5a-5d illustrate (with side sectional views) a sequence of steps employed for applying a protective layer to components of a sensor in accordance with the present invention, in which a consumable barrier is employed;

FIGS. 6a-6e illustrate (with side sectional views) a sequence of steps employed for assembling another sensor in accordance with the present invention;

FIG. 7 illustrates a side view of a sensor of the present invention attached directly to an ASIC device; and

FIG. 8a-8d illustrate (with side sectional views) a sequence of steps employed for assembling yet another sensor in accordance with the present invention.

### DETAILED DESCRIPTION OF THE PREFERRED EMBODIMENT

The present invention is predicated upon the discovery of methods for assembling a sensor that includes a sensing element that requires exposure over at least a portion of its outer surface to ambient conditions. More particularly, the present invention is predicated upon the discovery of methods for assembling a fluid sensor that includes a resonator sensing element that requires exposure over at least a portion of its outer surface to the fluid it is sensing.

One preferred method of the present invention generally includes the steps of:

providing a coated or uncoated sensor element having an exposed sensing surface;

attaching the sensor element to a platform so that the exposed sensing surface is spaced from the platform; and

optionally applying a protective layer over the platform and/or sensor while maintaining the exposed sensing surface.

In a particularly preferred embodiment, which is illustrated herein by description of a tuning fork resonator as the sensing element, a coated or uncoated tuning fork resonator is provided and has tines that are free to resonate upon application of an input signal (e.g., a varying frequency input signal). The resonator is attached to a platform in a manner that maintains the tines spaced from the platform. Optionally, a protective layer is applied over the resonator (other than over the tines) and the platform. It should be appreciated that even though the present invention is illustrated with reference to a tuning fork resonator (e.g., having two, three or more tines), the invention is not so limited. For example, the features herein may be employed with respect to any of a number of types of sensors, including for example, cantilevers, unimorphs, bi-morphs, membrane resonators, torsional resonators, or other mechanical resonators. The invention may also have suitable application with respect to thickness shear mode resonators, surface acoustic wave devices, pressure sensing devices, or ultrasonic transducers.

Examples of resonators and the manner of using them for sensing characteristics of a fluid are taught, for example, in U.S. Pat. Nos. 6,336,353 and 6,182,499, hereby expressly incorporated by reference.

FIG. 1 illustrates one example of an approach to packaging a resonator to form an assembly 10 in accordance with the present invention. The assembly 10 includes a resonator 12 having a free portion 14. A base platform 16 supports the resonator, by way of a suitable support 18, which may be formed as part of the base platform 16, added as a separate layer (e.g., a layer of dielectric material (e.g., a polymer, a ceramic or combination thereof), an adhesive such as an epoxy, or the like) or otherwise provided so that the free portion is spaced from the base platform over at least a portion of the length of the resonator. The assembly is preferably provided with a suitable structure adapted for receiving a signal. For example, in one embodiment, a conductive path 20 joins a contact 22 with the resonator (e.g., via a bonded or soldered joint with an electrode (not shown) associated with the resonator.

The structure of the conductive path and the contact is not critical, and it is possible to combine the two into a single structure. For example, it is possible that the conductive path may include a wire that is attached to an electrode of the resonator. Alternatively, using techniques common in the manufacture of semiconductor devices, a via may be formed in the base platform 16 and filled with a wire or conductive metal. The contact may be a wire. It may also be a conductive trace applied by a suitable metallization process (e.g., plating, physical vapor deposition, chemical vapor deposition, plasma deposition, coating, spraying, or the like). It may also be possible to laminate with or without an adhesive.

Though FIG. 1 depicts a structure by which the conductive path extends through a base, it will be appreciated that the invention is not so limited, and the path can extend through or around any wall, e.g., wall 24 of the assembly. The wall may be any suitable material, and preferably is a material similar in electrical characteristics to the material of the base platform 16 (e.g., a ceramic, a polymer or a combination thereof).

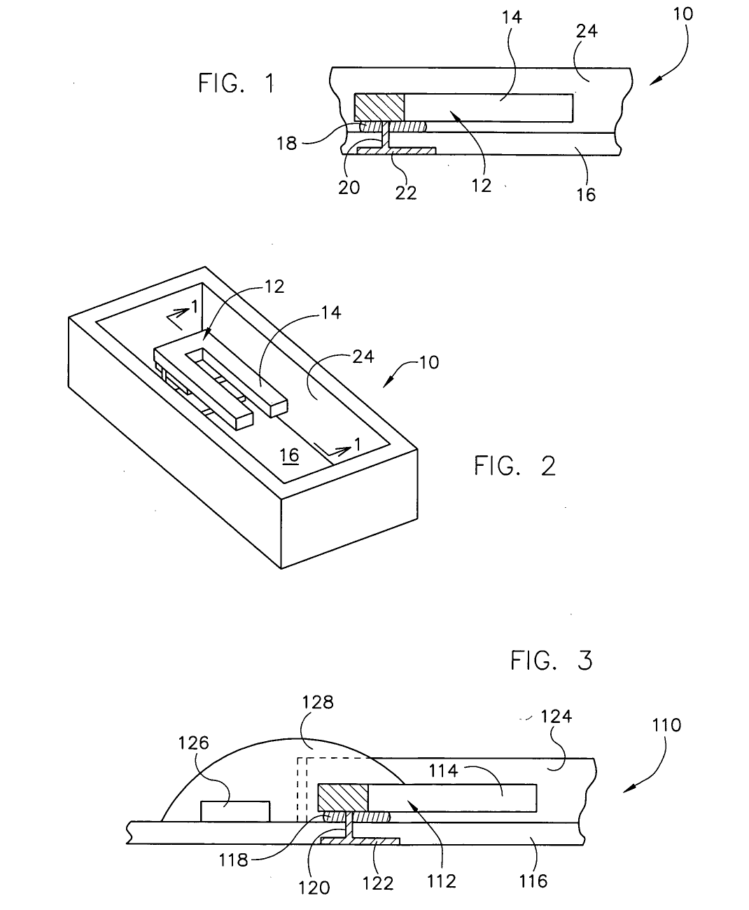

In FIG. 2, there is shown an example of a more complete housing structure in which the assembly 10 includes a plurality of walls 24 that substantially surround the resonator. Though shown as generally orthogonally disposed continuous, flat walls, of course, the invention is not so limiting, the walls can assume any shape as desired. They may include discontinuities, e.g., grooves, wells, apertures, slits, windows or some other surface irregularity. The walls may be curved, be configured as a polygon other than a rectangle, or combinations thereof. In a preferred embodiment, there is a cut-out defined in the housing structure so that at least the free end 14 of the resonator 12 is exposed. For example, as seen in FIG. 2, a top wall may be omitted from covering all or a portion of an upper portion of the housing structure to render at least a portion of the resonator exposed to ambient.

In another embodiment, an assembly including a resonator, such as the assembly in FIG. 1 may be combined with one or more other devices, and be carried together by a common platform. For examples, it is contemplated that a resonator assembly may be packaged in combination with an ASIC and be carried by a common platform. With reference to FIG. 3, there is shown one such example in which an assembly 110, including a resonator 112 having a free portion 114. A base platform 116 having a conductive path (which in this illustration is shown connected with a contact 122, but need not be, as described above) forms a surface upon which a support 118 may be disposed for the resonator 112. A wall 124 substantially surrounds the resonator 112, while at least partially exposing at least a portion of the resonator to ambient.

Also shown in FIG. 3 is an additional electronic component 126 (e.g., an ASIC). In FIG. 3 there is also shown an optional protective layer 128 that may be applied to encapsulate at least a portion of the assembly. It will be appreciated that a similar protective layer may be employed over the various other alternative assemblies of the present invention as well, such as over the assembly 10 of FIG. 1. It is not only limited to the assembly 110 of FIG. 3.

The protective layer 128 may be any suitable protective layer. For example, it may be a coating that is sprayed, brushed or otherwise applied over the assembly; it may also include an overmolded plastic layer, a layer that is laminated, or combinations of two or more of coatings, overmolded layers, or laminated layers may also be employed.

It is found that in instances where it is desired to employ a protective layer, and the need remains to maintain the free portion of the resonator exposed to ambient, there is a need to selectively apply the protective layer to the assembly so that components needing protection from harsh environments will be coated, while still keeping the free portion of the resonator exposed. In order to accomplish this, any of a number of suitable selective application techniques may be employed, such as the employment of a removable protective barrier to prevent protective layer materials from contacting the free portion of the resonator. The removable protective barrier is thus positioned over the assembly to block the portions of the assembly requiring the protective layer from the portions that do not require the layer. The protective layer is then applied and the barrier is removed.

The protective barrier may take any suitable configuration, but preferably is selected from a re-usable barrier or a consumable barrier. For example, it might be possible to employ a photoresist over a portion of the assembly, selectively remove portions thereof, apply the protective material and then remove remaining photoresist.

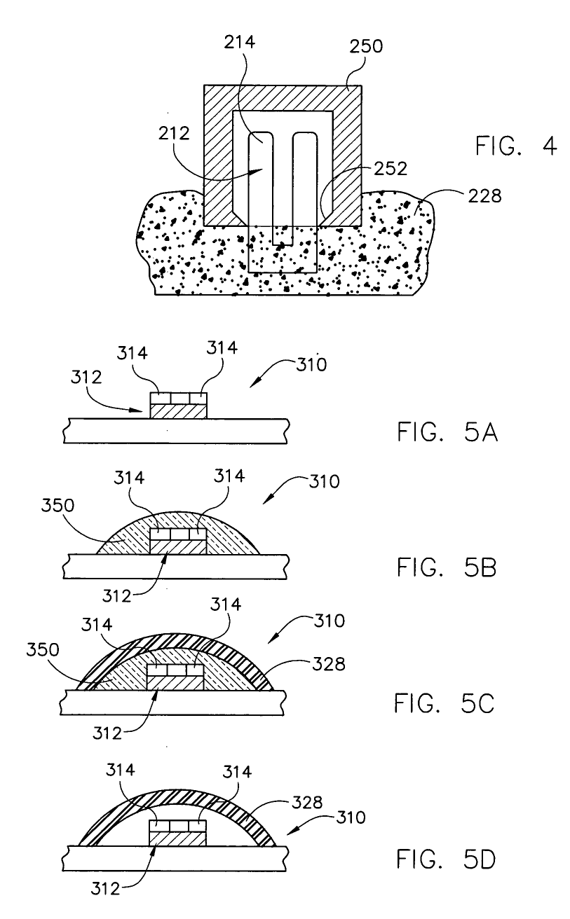

FIG. 4 is a top sectional view of a resonator assembly 210 in which a re-usable barrier 250 is employed to surround a resonator 212 over a free portion 214, while a protective layer 228 is applied. The re-usable barrier may be any suitable material. However, preferably it is a relatively soft material that will not plastically deform the resonator if it contacts the resonator. It may include one or more knife edges 252, membranes, walls or the like at any suitable location (e.g., a knife edge seal along an inner periphery) to help sealingly surround the resonator during application of the protective layer. It should be appreciated that though the barrier of this embodiment may be re-usable, it need not be, particularly if to do so would compromise the quality of the resulting assembly. The re-usable barrier may be manually handled, or handled by an automated instrument for placement purposes. In a variation within this embodiment, one or a plurality of the barriers may be placed on a robot arm, which precisely brings the barrier (or barriers) into proper position relative to the resonator.

FIGS. 5a-5d illustrate a sequence of steps that may be employed, pursuant to which the removable protective barrier is a consumable barrier. In FIG. 5a there is shown an assembly 310, that includes a resonator 312 having tines defining a free portion 214. The resonator sits on a platform 318. In FIG. 5b, a consumable barrier layer 350 is applied over the resonator of the assembly of FIG. 5a. In the step depicted in FIG. 5c, a protective layer 328 is applied over the consumable barrier layer 350. In FIG. 5d, the consumable layer has been removed. Leaving the protective layer 328 in spaced relation from the resonator 312.

In yet another embodiment it may be possible to employ a hybrid approach to the approach of FIGS. 4 and 5a-5d. For example, a shell may be formed in situ to surround the resonator. Upon conclusion of application of the protective layer, the shell may be removed, such as by breaking it at a weakened region (e.g., a scored location).

It is preferable that any consumable barrier material that is used be relatively inert to the material of the resonator and any associated hardware so that no damage arises as a result of the method. In this regard, any of a number of different materials may be employed as the consumable layer. For example, the material of the consumable barrier may be a material that can be dissolved, decomposed or otherwise broken down into particles for removal from the volume of space between the resonator and any resulting protective layer. Thus, the consumable barrier material may be selected from polymers (synthetic, biological, thermoplastic, thermoset, or combinations thereof), starches, waxes, salts or other dissolvable crystals, low melting point metals, or another sacrificial material that is capable of withstanding in its solid state the processing conditions for applying the protective layer, and thereafter being removable from the assembly without physically deforming or otherwise contaminating the resonator.

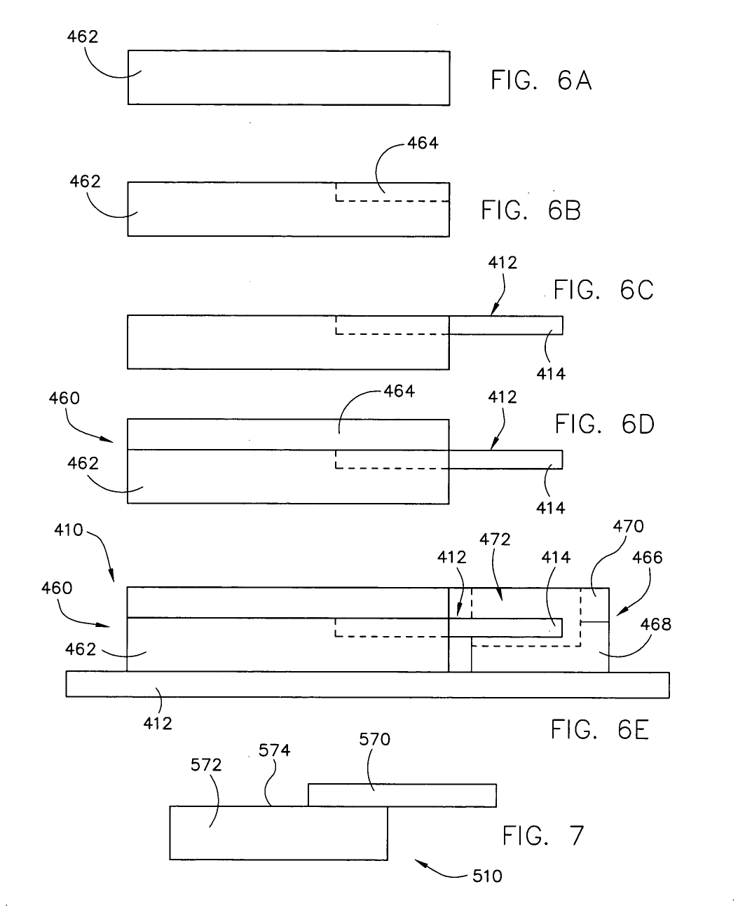

Turning now to the embodiment shown in FIGS. 6a-6e, there is shown another approach to the fabrication of an assembly 410 in accordance with the present invention. In the resulting assembly of this embodiment, a resonator 412 has a free portion 414 that extends away from a multi-layer holder 460. A first layer 462 is provided as shown in FIG. 6a. A trench 464 is formed in or on the first layer, as seen in FIG. 6b, using any suitable material removal or material build-up technique (e.g., etching, machining or the like for removal, or plating, physical vapor deposition, chemical vapor deposition, plasma deposition, coating, spraying, laminating with or without adhesive or the like, for build-up of spaced walls (not shown) for defining a trench).

According to FIG. 6c, the resonator 412 is placed in the trench so that the free portion projects away from the first layer 462. Though it may be possible to mechanically fasten the resonator into the trench, or to adhesively bond it in place, FIG. 6d illustrates the placement of a second layer 464 over at least a portion of the first layer 462. The second layer may be fabricated on the first layer using any suitable technique such as attaching a preformed layer, such as by laminating with or without an adhesive, plating, physical vapor deposition, chemical vapor deposition, plasma deposition, coating, spraying, or the like. At this point the multi-layer holder 460 is complete and may be implemented into a further assembly. In FIG. 6e, there is shown one illustration of how the holder 460 may be incorporated into a further assembly, such as by attachment (e.g., via welding, adhesive bonding, wire bonding or the like). In the embodiment of FIG. 6e, a shield device 466 is fabricated to include a protective shield for the free portion of the resonator, while still maintaining the free portion 414 exposed for sensing. Thus, a lower portion 468 is assembled with an upper portion 470 about the resonator 412. Either or both of the lower portion 468 or the upper portion 470 may include a window that exposes the free end for sensing. The lower portion 468, the upper portion 470 or both may be pre-fabricated to include a suitable cavity 472 for receiving the resonator. The lower portion 468 and the upper portion 470 might also be fabricated separately, or as a single unit (e.g., as a molded plastic clam-shell type package). Though shown in FIG. 6e as being carried by a common platform 412, the holder 460 and shield device 466 may be maintained upon separate support surfaces.

FIG. 7 illustrates a side view of an assembly 510 in which a sensor 570 including a resonator is attached directly to another device, particularly an ASIC device 572. Though shown mounted on an outer surface 574 of the ASIC device 572, the sensor may penetrate through such an outer surface to an interior of the ASIC device. Attachment of the sensor to the ASIC device may be by any suitable technique, such as (without limitation) via welding, adhesive bonding, wire bonding or the like. The sensor 570 may simply include a resonator, or it may also be an assembly that includes additional packaging, such as that depicted in the various other embodiments as shown herein (e.g., as in FIGS. 1-6d and 8a-8d).

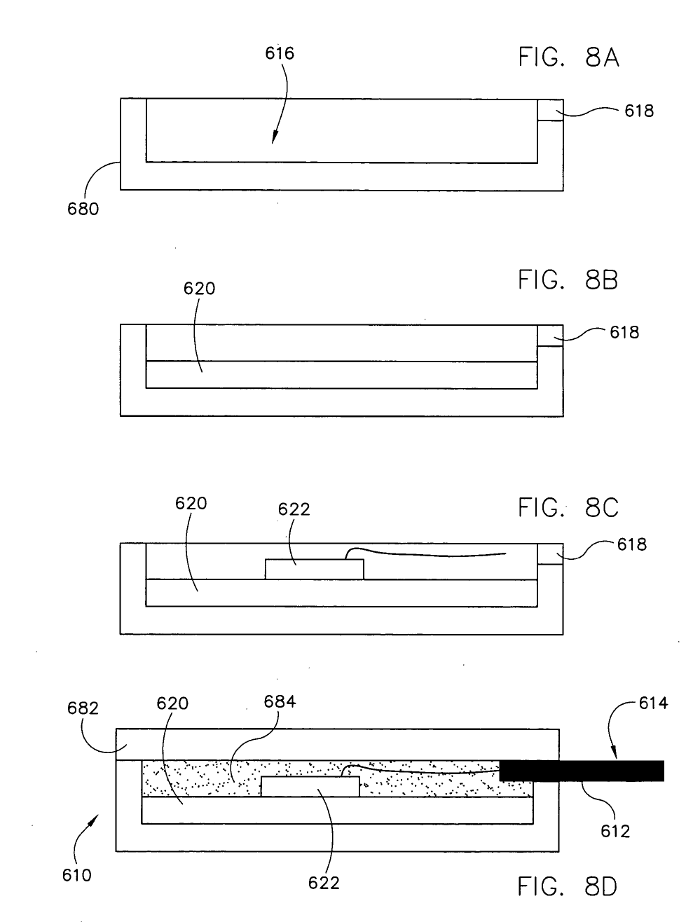

Turning now to FIGS. 8a-8d, there is shown yet another embodiment of the present invention in which an assembly 610 includes a first portion 680 and a second portion 682 that are attached together in a later-stage assembly step to enclose the assembly while leave a free portion 614 of resonator 612 exposed for sensing. It should be realized that a suitable shield device, such as shown in FIG. 6e may likewise be employed with the present assembly 612. As seen in FIG. 8a, preferably at least one (or both) of the first or second portions will be configured to include a well 616 for receiving components. Optionally, it may also have a suitable wall structure for defining a opening 618, through or on which the resonator 612 may be placed.

In FIG. 8b a first internal component 620 is placed in the well 616. In the step shown in FIG. 8c, a second internal component 622 (which may be pre-attached to or otherwise integrated into the first component, or omitted altogether) is placed in the well 616. Optionally, an electrical conductor 624 (e.g., wires, traces or otherwise) is attached to either or both of the first or second internal components. Pursuant to FIG. 8d, the resonator is connected with the electrical conductor, the second portion 682 is secured to the first portion (e.g., mechanically, by welding, by adhesive bonding or otherwise), and the well is optionally filled with an inert substance 684 (e.g., a gas, a gel, a liquid or otherwise).

Thereafter, the resulting assembly can be further handled (e.g., for placement on a common platform with an ASIC, for placement on an ASIC (as in FIG. 7) or otherwise), such as for attachment to a platform or to hardware for securing it in place in the intended sensing environment. It should be recognized that either of the first or second components might be an ASIC component.

As discussed in the above, in certain embodiments of the present invention it is preferable that a spacing be maintained between the free portion of any resonator and any adjacent structure. The amount of such spacing is not critical, and may vary depending upon the nature of the particular application. However, in the context of a preferred embodiment employing a tuning fork resonator, in order to help avoid the potential for electrical interference with the operation of the resonator, it is preferred that the spacing be at least one width of a tine of the tuning fork.

In any of the embodiments discussed herein, it is also possible that one or more additional structures are added to the assembly in order to help improve performance or functionality of the resulting device. For example, in one embodiment, the assembly includes a well or other suitable passage that is in direct fluid communication with the resonator and into which a calibration fluid can be introduced for the purpose of calibrating the sensor. It is also contemplated that the assembly may include a structure that substantially envelops the resonator for assisting to preserve electrical characteristics. For example, a wire mesh or other like cover may be provided about the resonator as a Faraday cage. Other alternative structures may also be employed, such as the metallization of a region that at least partially surrounds the resonator. This can be employed in any of the above embodiments, including for example the embodiments of FIGS. 1-3 that employ a housing structure, or the embodiments of FIGS. 6a-6e and 8a-8d that might employ a shield device (which shield device, of course, may also be adapted for employment with a housing such as in FIGS. 1-3).

It should be appreciated that the functions that are described herein may be performed as part of a single integrated package, or they may be spread over a plurality of different components that may or may not be supported by a common platform.

Further, the present invention also contemplates the incorporation of one or more additional sensors apart from the resonator sensors described herein. For example, one embodiment contemplates the inclusion in an assembly of a sensor or other device for monitoring temperature, such as a thermistor, an RTD or other such temperature sensor. In this manner, it is contemplated that all of the data necessary for a calculation of viscosity, for example, can be obtained in a single assembly, which in turn can be interfaced with a suitable microprocessor.

It should be recognized that the present invention contemplates not only the methods employed for fabricating the assemblies of the present invention, but also the assemblies themselves, independent of the methods employed for fabrication. Thus the present invention contemplates sensor assemblies that include a resonator having a free portion with a sensing surface is incorporated onto a platform, wherein components of the sensor are physically shielded from harsh operating conditions, a spacing is maintained between the free portion of the resonator and the platform, and the sensing surface of the resonator is exposed for sensing.

The assemblies of the present invention may also be provided with suitable hardware for securing the assembly to another component, such as hardware for securing the assembly in an automotive vehicle engine or within a conduit, tank, or other structure for carrying a fluid.

It should also be recognized that even if not described in connection with one of the above embodiments, it is possible to combine steps from one of the embodiments shown with the other embodiments shown. For example, for each of the embodiments, it is contemplated that a protective layer may be applied over at least a portion of the resulting assemblies. This can be done by overmolding, coating or other art-disclosed techniques for protecting delicate hardware from the effects of intended operating conditions. Additionally, even if not shown, each of the embodiments might be further assembled onto a platform alone or with other components using art-disclosed attachment techniques (e.g., via welding, adhesive bonding, wire bonding or the like).

It should also be recognized that single layers shown herein may be split into additional layers to form more than the number of layers shown, or combined with other layers to form less than the number of layers shown. All such variations are contemplated within the scope of the present invention.

Further, the disclosure herein of a particular shape or orientation of a component is not intended as limiting. Though it is expected that many embodiments will employ relatively thin and flat structures, the components may also be fabricated or arranged so that the resulting structure has a curvature, a relatively thick profile, or a combination thereof (e.g., an assembly including a resonator and protective carrier structure that has a ratio of its largest to its smallest dimension of about 1:1 to about 4:1).

Finally, the omission herein in any particular embodiment of any discussion of electrical connections or other hardware for signally connecting the assemblies herein with other electronic components is not intended as limiting. It should be recognized that a variety of art-disclosed hardware configurations may be employed in each instance, such as the use of wires, traces, conductive metal filled vias, cominations thereof or the like.

As discussed above, the sensor may be a mechanical resonator, such as is disclosed for example in commonly owned, co-pending application entitled “Performance tuned mechanical resonators for sensing” (attorney docket No.1012-189), incorporated by reference herein. The mechanical resonator has a resonator portion for resonating in a fluid and an electrical connection between the resonator portion and a source of a signal input. The resonator portion, the electrical connection or both include a base material and a performance-tuning material. The base material may include quartz, lithium niobate, zinc oxide, lead zirconate titanate (PZT), gallo-germanates (e.g., Langasite (La₃Ga₅SiO₁₄), Langanite, or Langatate), diomignite (lithium tetraborate), bismuth germanium oxide gallium phosphate, gallium nitride, aluminum nitride or combinations thereof. The performance-tuning material may include polymers, ceramics, metals, metal carbides or nitrides, diamond, diamond-like carbon, and combinations thereof.

The mechanical resonator may be connected to a measuring system that sends a variable frequency input signal, such as a sinusoidal wave, that sweeps over a predetermined frequency range, preferably less than about 100 kHz (e.g., in the 25-30 kHz range) for a tuning fork resonator and in a higher range for the TSM resonator. The resonator response over the frequency range is then monitored to determine selected physical and electrical properties of the fluid. Absolute values may be obtained if desired, as may relative, comparative or index values. Additionally, it is possible also that the system may be employed with determining whether a certain threshold criteria is met in the fluid being analyzed.

The hardware for the present measuring system may be any suitable hardware. It may include, for example, art-disclosed network analyzers, see, e.g., U.S. Pat. No. 6,336,353 (Matsiev, et al.)(“Method and apparatus for characterizing materials by using a mechanical resonator”); and U.S. Pat. No. 6,182,499 (McFarland, et al.) and published U.S. Patent Application No. 20030000291, hereby incorporated by reference. The hardware might also be part of an application specific integrated circuit (ASIC), such as is disclosed for example in commonly owned, co-pending application entitled “Integrated measurement assembly for a machine fluid sensing system” (U.S. patent application Ser. No. 10/452,264), hereby incorporated by reference, as disclosed in commonly owned, co-pending application entitled “Application specific integrated circuitry for controlling analysis of a fluid” (attorney docket no. SYMXP001.P), claiming benefit of U.S. provisional application No. 60/419,404), hereby incorporated by reference, as disclosed in co-owned, co-pending application entitled “Resonator Sensor Assembly” (attorney docket nos. 1012-188WO1 and 1012-188WO2, claiming benefit of U.S. provisional 60/456,517), as disclosed in co-owned, co-pending application entitled “Environmental Control System Fluid Sensing System And Method” (International patent application no. US03/32983) or as disclosed in co-owned, co-pending application entitled “Mechanical Resonators” (attorney docket nos. 1012-189 and 1012-189WO, claiming benefit of U.S. provisional application No. 60/452,292). All of the foregoing are hereby incorporated by reference.

Generally, the hardware for measuring system provides a versatile fluid sensing system. More specifically, the hardware provides a fluid sensing system for machines that rely upon the presence, condition or both of a fluid to maintain efficient operation, such as (without limitation) a synthetic or natural engine oil. In an automotive application, the user is provided with the ability to determine the actual condition (e.g. or the relative deviation of the state of the engine oil from its initial or virgin state) of the engine oil at any particular time, including during operation. Alternatively, in conjunction with assessing fluid condition, the hardware may also determine the amount of fluid remaining in a reserve of an assembly. This advantageously allows machine operators to extend the duration between fluid service events, while helping to assure continued operational integrity of a machine.

Any dynamic assembly that depends on fluids to operate (e.g., where friction and heat are of a concern), will benefit from hardware capable sensing the state of a fluid. For instance, the ability to dynamically monitor fluid condition, process data obtained from the monitoring, and report characteristics of the fluid to an interface or operator can have many applications. Assemblies that may benefit from the defined embodiments of the present invention are many, and can include without limitation, engines in general, automobiles, heavy machinery, military equipment, airplane parts, oil drilling, exploration and production well logging, oil refining, pipeline and quality control applications, marine transportation, sub-sea exploration and aerospace related equipment, or any other fluid containing application. In addition, contemplated methods include a step of assembling the hardware into a device that is incorporated into engines in general, automobiles, heavy machinery, military equipment, airplanes, oil drilling, exploration and production well logging equipment, oil refining, pipeline and quality control equipment, marine transportation equipment, sub-sea exploration and aerospace related equipment, or any other equipment that utilizes fluids for operations.

In the automotive field, numerous components require lubrication, which is not limited to engine oil. For example, other automotive components may include the transmission, the transfer case, the differential, etc. Still further, the sensing system may further be used to determined the quality and amount of other fluids which are not necessarily used predominantly as a lubricant, including: brake fluids, steering fluids, antifreeze fluids, refrigerant fluids, windshield washer fluids, or any other fluid located in an automotive system.

In one embodiment of suitable hardware, an oil sensing system is used to determine the component characteristics and amount of engine oil. In an automotive application, the oil sensing system will provide a user, at a minimum, with a warning as to the need to change the oil (such as owing to the presence of contaminants, a breakdown or loss of useful ingredients or otherwise). In such an application, the warning is essentially informing the user of the automobile that the engine oil has reaches a quality level or condition that is lower than that recommend by the automobile's manufacturer (or set by the oil manufacturer).

The fluid sensing system preferably uses a mechanical resonator as the fluid sensor in accordance with the present invention. The mechanical resonator is at least partially contained in the fluid under-test. To monitor the condition of the fluid under-test (i.e., engine oil), the mechanical resonator is provided with electrical energy through a frequency generator. The frequency generator is designed to apply a frequency signal (to the mechanical resonator) that is swept over a predetermined frequency range. Electronics are then used to detect the response signal from the mechanical resonator and process the signal to ascertain characteristics of the fluid under-test. In an embodiment of the fluid sensing system, the electronics are provided in the form of an application specific integrated circuit (ASIC). In addition, the hardware might also be part of or include a field programmable gate array (FPGA).

In the foregoing description, numerous specific details are set forth in order to provide a thorough understanding of the fluid sensing system, hardware and mechanical resonator that may be used with the present invention. It will be apparent, however, to one skilled in the art that the present invention may be practiced without some or all of these specific details. In other instances, well known process steps have not been described in detail in order not to unnecessarily obscure the present invention.

The manner of operating the resonators and sensors of the present invention may vary. In one embodiment, the sensor is operated continuously. In another, it may be intermittently operated. It is possible that the sensor may be operated only in preselected conditions, such as prior to starting vehicle operation, upon starting vehicle operation, during vehicle operation upon concluding vehicle operation, while the vehicle travels at a substantially constant velocity, while the vehicle accelerates or decelerates, or otherwise.

It should be understood that various alternatives to the embodiments of the invention described herein may be employed in practicing the invention. It is intended that the following claims define the scope of the invention and that the methods and apparatus within the scope of these claims and their equivalents be covered thereby. To the extent that the particular combinations of steps and materials covered by the following claims are not disclosed in the specification, the combinations of steps and materials are incorporated by reference into the specification.

What is claimed is:

1. A method of packaging a resonator sensor for analyzing a fluid, comprising:
forming an assembly by a method that includes
affixing an electronic component to a platform, and
affixing a resonator to the platform, to provide a sensing surface for exposure to the fluid and to provide a spaced relationship between the exposed sensing surface and the platform; and
encapsulating at least a portion of the assembly in a protective layer.

2. The method according to claim 1, wherein the platform comprises a curved wall.

3. The method according to claim 1, further comprising a support disposed between the platform and the resonator, wherein the support is selected from a polymer, a ceramic or a combination thereof.

4. The method according to claim 3, further comprising an electrical conductor connecting the resonator to the platform.

5. The method according to claim 4, wherein the resonator is a tuning fork.

6. The method according to claim 5, wherein a base material of the tuning fork comprises quartz, lithium niobate, zinc oxide, lead zirconate titanate (PZT), gallo-germanates (e.g., Langasite (La₃Ga₅SiO₁₄), Langanite, or Langatate), diomignite (lithium tetraborate), bismuth germanium oxide gallium phosphate, gallium nitride, aluminum nitride or combinations thereof, and the tuning fork comprises a coating that comprises a material selected from polymers, ceramics, metals, metal carbides or nitrides, diamond, diamond-like carbon, and combinations thereof.

7. The method according to claim 1, further comprising operating the resonator sensor in automotive vehicle for analyzing the condition of an engine oil.

8. The method according to claim 7, wherein the resonator is operated at frequency of less than about 1 MHz.

9. The method according to claim 1, wherein the encapsulating step comprises applying a protective layer covering the platform and the resonator while maintaining the exposed sensing surface such that the exposed sensing surface can displace the fluid in contact therewith.

10. The method according to claim 9, wherein the protective layer is selectively applied by spraying, brushing, over molding, laminating or by combinations thereof.

11. The method according to claim 9, further including blocking the exposed sensing surface with a removable protective barrier prior to applying the protective layer.

12. The method according to claim 11, wherein the removable protective barrier is a reusable or consumable barrier.

13. The method according to claim 12, wherein the removable protective barrier is a consumable barrier that comprises a polymer, starch, wax, salt or other dissolvable crystal, low melting point metal, a photoresist, or another sacrificial material.

14. The method according to claim 12 wherein the removable protective barrier is a reusable barrier that comprises a relatively soft material that will not plastically deform the resonator if it contacts the resonator.

15. A method of packaging a flexural resonator sensor for analyzing a fluid, comprising:
forming an assembly by a method that includes
affixing an electronic component to a platform
affixing a coated or uncoated flexural resonator, having a sensing surface for exposure to the fluid, to the platform with a conductive path therebetween, wherein a spaced relationship is created between the exposed sensing surface and the platform; and
encapsulating at least a portion of the assembly in a protective layer.

16. The method according to claim 15, further comprising a support disposed between the platform and the resonator, wherein the support is selected from a polymer, a ceramic or a combination thereof.

17. The method according to claim 16, further comprising a wire conductor connecting the resonator to the platform.

18. The method according to claim 15, further comprising operating the resonator sensor in automotive vehicle for analyzing the condition of an engine oil.

19. The method according to claim 18, wherein the resonator is operated at frequency of less than about 1 MHz.

20. A method of packaging a tuning fork resonator fluid sensor assembly, comprising:
forming an assembly by a method that includes
attaching an application specific integrated circuit to a platform;
affixing a tuning fork resonator, having a coated sensing surface for exposure to a fluid, to the platform, the sensing surface of the tuning fork resonator being coated with a support layer selected from a polymer, a ceramic, or combination thereof, and a conductive path between the integrated circuit and the tuning fork resonator, wherein a spaced relationship of at least one width of at least one tine of the tuning fork is created between the exposed sensing surface and the platform; and
applying a protective layer to encapsulate at least a portion of the assembly, the encapsulated portion of the assembly comprising the application specific integrated circuit, the protective layer being effective to protect the integrated circuit from operating conditions over a temperature range of at least −40° C. to 170° C., while allowing the sensing surface of the resonator to be exposed to the fluid.

21. A method of packaging a resonator sensor for analyzing a fluid, comprising:
affixing a resonator to a platform, to provide a sensing surface of the resonator for exposure to the fluid and to provide a spaced relationship between the exposed sensing surface and the platform, wherein a support is disposed between the resonator and the platform, and the resonator is connected to the platform with a conductive path, and
providing a housing substantially surrounding the resonator while maintaining exposure of the sensing surface to the fluid.

22. A resonator sensor for analyzing a fluid, comprising
an assembly comprising (i) an electronic component on, including affixed to or integral with, a platform, and (ii) a resonator having a sensing surface for exposure to the fluid, the resonator being on, including affixed to or integral with, the platform with a spaced relationship between the sensing surface and the platform, the resonator being in electrical communication with the electronic component, and
a protective layer encapsulating at least a portion of the assembly.

23. A resonator sensor for analyzing a fluid, comprising:
an assembly comprising (i) an electronic component on, including affixed to or integral with, a platform, (ii) a coated or uncoated flexural resonator having a sensing surface for exposure to the fluid, the flexural resonator being on, including affixed to or integral with, the platform with a spaced relationship between the sensing surface and the platform, and (iii) a conductive path between the electronic component and the flexural resonator; and
a protective layer encapsulating at least a portion of the assembly.

24. The resonator sensor of claims 22 or 23 wherein the resonator is a flexural resonator adapted so that the sensing surface of the resonator can displace fluid during operation of the sensor.

25. The resonator sensor of claims 22 or 23 wherein the resonator is a tuning fork resonator.

26. A resonator sensor for analyzing a fluid, comprising:
an assembly comprising (i) an integrated circuit on, including affixed to or integral with, a platform, (ii) a tuning fork resonator having a sensing surface for exposure to a fluid, the tuning fork resonator being on, including affixed to or integral with, the platform with a spaced relationship between the exposed sensing surface and the platform, and (iii) a conductive path between the integrated circuit and the tuning fork resonator; and
a protective layer encapsulating at least a portion of the assembly, the encapsulated portion of the assembly comprising the integrated circuit, the protective layer being effective to protect the integrated circuit from operating conditions of the fluid while allowing the sensing surface of the resonator to be exposed to the fluid.

27. The resonator sensor of claim 26 wherein the protective layer is effective to protect the integrated circuit from operating conditions comprising a temperature range of at least −40° C. to 170° C.

28. The resonator sensor of claim 26 wherein the sensing surface of the tuning fork resonator is coated with a support layer selected from a polymer, a ceramic, or combination thereof.

29. The resonator sensor of claim 26 wherein the spaced relationship between the exposed sensing surface and the platform is at least one width of at least one tine of the tuning fork.

30. A resonator sensor for analyzing a fluid, comprising:
a resonator having a sensing surface for exposure to the fluid, the resonator being affixed to a platform with a spaced relationship between the exposed sensing surface and the platform,
a support disposed between the resonator and the platform,
a conductive path for electrically connecting the resonator to a circuit for for providing stimulus to the flexural resonator and for receiving a response signal from the flexural resonator, and
a housing comprising at least one wall and substantially surrounding the resonator while maintaining exposure of the sensing surface to the fluid.
